(19) United States
(12) Patent Application Publication
(10) Pub. No.: US 2011/0268265 A1
(43) Pub. Date: Nov. 3, 2011

(54) DISK MEDIA SECURITY SYSTEM AND METHOD

(76) Inventor: ALEXANDER M. LATHROP, Colorado Springs, CO (US)

(21) Appl. No.: 12/771,964

(22) Filed: Apr. 30, 2010

(51) Int. Cl. G11B 7/085; H04L 9/28

(52) U.S. Cl. 380/28; 369/30.03; G9B/7.042

(57) ABSTRACT

A system and method for secure writing to a disk are disclosed for securely writing live data to the disk. A free space of the disk after the live data is written to the disk is determined. Random bits are generated for the free space. At least some of the random bits are written to the disk to fill the free space in a first part of a write process. The live data is written to the disk in a second part of the write process adapted to begin at a terminus of the free space on the disk and continue until all of the live data is written to the disk.

### BACKGROUND

This disclosure relates generally to data security, and more particularly to system and method for data security when writing data to a removable media such as a disk or other media.

When a compact disk (CD), digital video disk (DVD) or other disk media is “burned”, (i.e. files are copied to the disk), it is possible to burn more files to the same disk at a later time, hiding the original data. For convenience and simplicity, disk media of any type is hereinafter referred to as a “CD”. If a CD is burned more than once, only the new, recently burned files should be accessible when a representation of the contents of the disk is displayed by a computer. However, some or all of the original files may still be intact on the CD and can be retrieved by numerous file retrieval programs.

### SUMMARY

In general, this document discloses a system and method for burning data to a CD so that unused space of the CD cannot be written onto later to hide the earlier burned data. This system and method ensures that a CD can only be burned once, thereby providing a robust measure of security, reliability and integrity of the data burned on the CD.

In one aspect, a method for secure writing to a disk is presented. The method includes the steps of providing live data for being written to the disk, determining a free space of the disk after the live data is written to the disk, and generating random bits to fill the free space. The method further includes writing at least some of the random bits to fill the free space of the disk in a first part of a write process, and writing the live data to the disk in a second part of the write process adapted to begin at a terminus of the free space on the disk and continue until all of the live data is written to the disk.

In another aspect, a system for secure writing to a disk is presented. The system includes a memory that stores live data for being written to the disk, a processor that determines a free space of the disk after the live data is written to the disk, and a random bit generator that generates random bits in a quantity sufficient to fill the free space. The system further includes a data writer under control of the processor for accessing the live data from the memory, for writing at least some of the random bits to fill the free space of the disk in a first part of a write process, and for writing the live data to the disk in a second part of the write process adapted to begin at a terminus of the free space on the disk and continue until all of the live data is written to the disk.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a computing system to implement a disk media security system and method.

FIG. 2 illustrates a system block diagram of computer system for executing the disk media security system and method.

FIG. 3 shows a networked alternative for a disk media security system.

FIG. 4 is a functional block diagram of a disk media security system.

FIG. 5 is a flowchart of a disk media security method.

FIG. 6 illustrates an operation of a disk media security system.

Like reference symbols in the various drawings indicate like elements.

### DETAILED DESCRIPTION

This document describes a system and method for writing data to a disk, so that unused space of the disk cannot be written onto later to hide yet not eliminate the earlier burned data, and ensuring that a disk can only be burned once. Accordingly, the system and method described herein provides a robust measure of security, reliability and integrity of the data burned on the disk.

As used herein, the term “bit” represents the smallest unit of digital computer information, i.e. a single “1” or a “0”. Data is referred to as an arrangement of bits on computer-readable media to form information, such as documents, programs. One form of data used herein is “live data,” which is a term used in this document to describe information that is intentionally generated for a specific purpose, and is the important data to be securely written to a disk. Another form of data is referred to herein as “dummy data,” which term refers to a collection of randomly-generated bits that provide no intentional information.

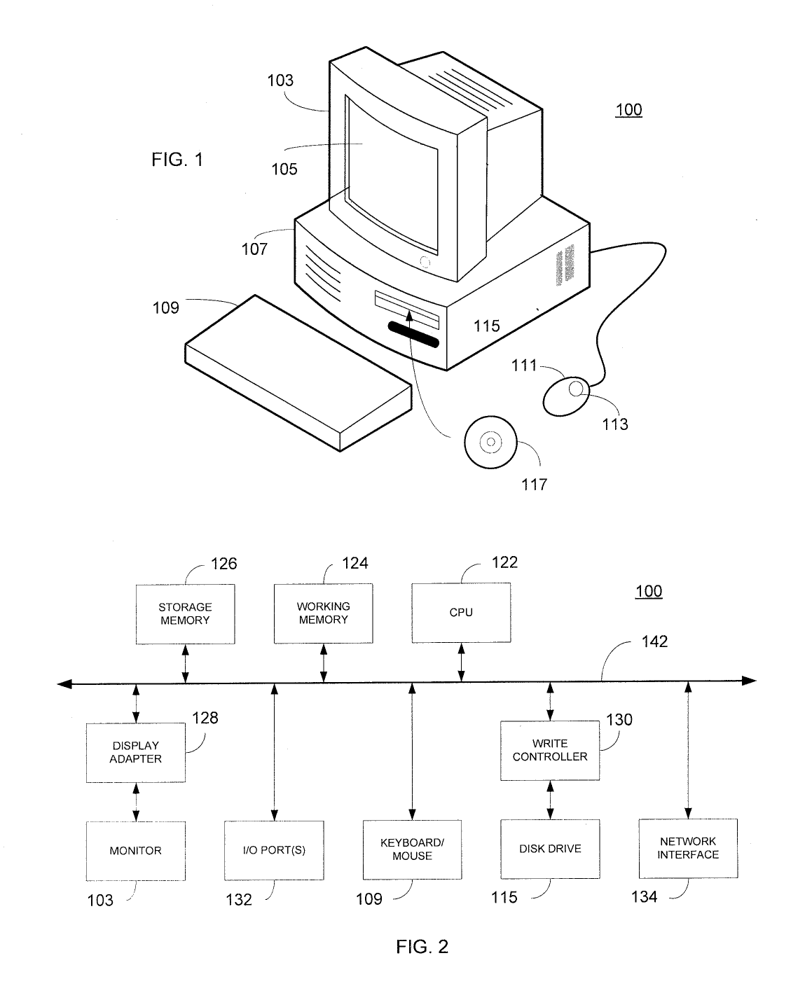

FIG. 1 illustrates an example of a computer system 100 that can be used to execute one or more implementations of a disk media security system and method. FIG. 1 shows a computer system 100 which includes a monitor 103, display screen 105, housing 107, keyboard 109, and mouse 111. Mouse 111 may have one or more buttons such as mouse buttons 113. Housing 107 is shown containing disk drive 115 for writing to and reading one or more of various disk media 117, such as CD-R, CD-RW, DVD or the like. Housing 107 also houses familiar computer components (not shown) such as a processor, memory, disk drives, and the like.

FIG. 2 shows a system block diagram of computer system 100 suitable for executing the disk media security system and method as described herein. As in FIG. 1, computer system 100 includes monitor 103 and keyboard or mouse 109. Computer system 100 further includes subsystems such as a central processor 122, system memory 124, storage memory 126 such as a hard disk drive, display adapter 128, input/output ports 132 such as a universal serial bus (USB) or firewire, and network interface 134 to connect the computer system 100 with a communications network such as the Internet, and intranet, local area network, or the like. Other computer systems suitable for use with the present invention may include additional or fewer subsystems. For example, another computer system could include more than one processor 122 (i.e., a multi- or parallel-processor system), or a computer system may include one or more cache memories.

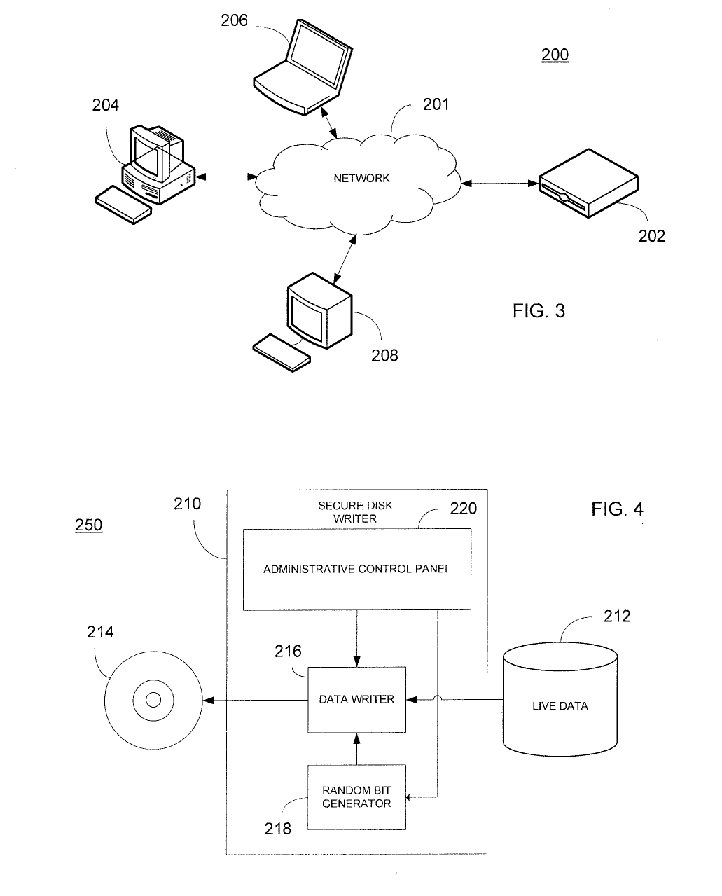

Arrows such as 142 represent a system communication bus architecture of the computer system 100. However, these arrows are merely illustrative of an interconnection or communication scheme serving to link the subsystems. Computer system 100 shown in FIG. 3 is but one example of a computer system suitable for use with the disk media security system and method. Other configurations or subsystems suitable for use with the disk media security system and method will be readily apparent to one of ordinary skill in the art.

FIG. 3 illustrates a computer network 200 in which a number of computer systems communicate with each other and other devices through a communications network 201, and can transmit data information to be written on a disk media by network drive 202. Communications network 201 can be any network that can transmit electronic information as data or other format, and can include wireless communication links as well as physical transmission links. The computer systems can include desktop computers 204, laptop computers 206, and data entry terminals 208.

Whether in a computer network 200 as illustrated in FIG. 3 or in a computer system 100 as shown in FIGS. 1 and 2, a disk media security system 250 includes a secure disk writer 210 for writing live data from a data store 212 to a disk 214, such as a CD, DVD or other disk medium. The secure disk writer 210 can be implemented as a local software application that is resident on the computer system 100 of FIGS. 1 and 2, or as a distributed or web-based software service that can be transmitted over a network from a server computer to a computer system.

Additionally, the disk writer 210 may include various hardware modules, or combination of hardware and software, for physically writing live data from the data store 212 to the disk 214, including a disk writer 216. The disk writer 216 is under control of an administration control panel 220 that provides controls in a customizable user interface for a user, such as, for example, to display 105 of monitor 103, and which translates user inputs to the user interface into commands.

Exemplary controls include: settings for available disk media to use (i.e. CD-R vs. CD-RW, DVD, etc.); options for which users are allowed writing capabilities, such as by account (local, Network or network group, etc.); and an option to save data that has been written to a network drive, whether at the time the disk is being written to or at another time. If data is stored to a network drive, then the entire live data or just the file name(s) and size(s) of the live data can be selected to be saved. If a “network copy” function is turned on and there is no network conductivity, then the secure disk writer 210 will be inoperable.

The disk media security system 250 further includes a random bit generator 218, also under control of the administrative control panel 220. To write the live data onto the disk 214 securely, i.e., where it is impossible for any user to burn more files to the same disk at later time to hide the original data, the live data is placed at the end of the available sectors of the disk so that the writing process cannot be stopped early. Random bits from the random bit generator 218 are then written to the disk to fill all the unused space or sectors of the disk. Data written to the disk 214 can be encrypted according to any number of policies, whether on a standalone computer system or on a network.

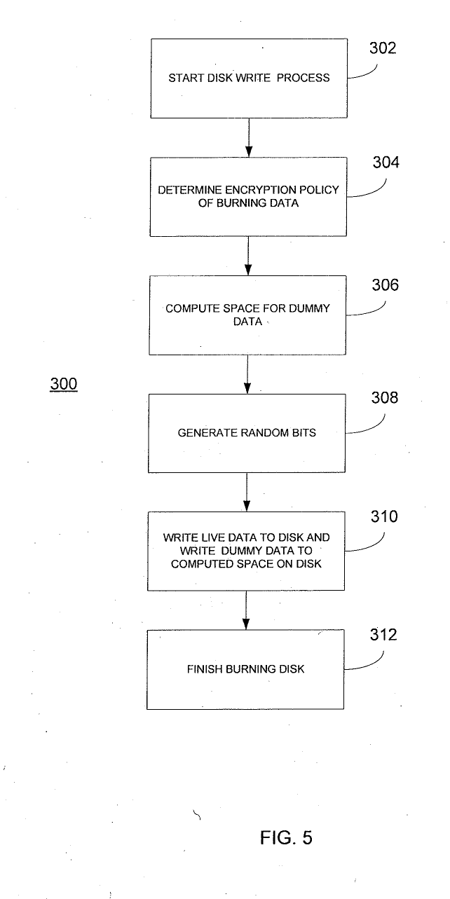

FIG. 5 is a flowchart of a disk media security method 300 to securely write live data (documents, files or other information) to a disk. At 302, a command to start writing (i.e. “burning”) data to a disk is received. At 304, it is determined whether an encryption policy is to be used for burning the data to the disk. If encryption is used, the disk media system can be configured to decrypt the data if the password or code used to encrypt the data is lost or misplaced. At 306, a space for dummy data is computed. The available space is first calculated, and the location of the end of the available space is determined. such that. During this step, the system can verify that the disk to be written to does not contain any existing data, particularly on “write once” disks. If data on such disks is present, the system rejects the disk. On rewritable disks, the system deletes the existing data before any other data is written to the disk.

At 308, random bits are generated, in an amount necessary to fill a remaining free space of the disk after the desired live data has been completely written to a live space the disk. At 310, live data is written to the disk, beginning at the end of the available space or sectors of the disk to not overwrite any data already written to the disk, and any unused space on the disk after the live data has been written, as computed at 306, is filled with dummy data until the entire disk is filled with data, either live data or random bits of dummy data, at 312. Accordingly, all available space on the disk is used so that it does not have any space available to write new data that would hide original data. In various alternative implementations, the dummy data can be written before, after, or any combination of before and after the live data.

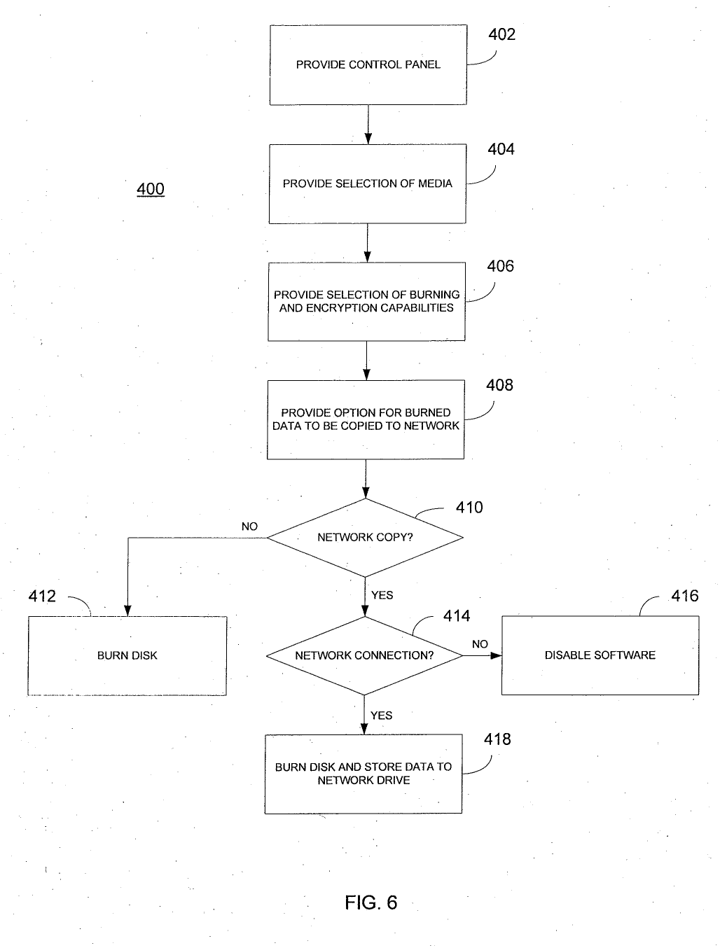

FIG. 6 is a flowchart of operations 400 for a disk media security system, which can be executed on a computer system or on a network of computer systems. At 402, the disk media security system provides a control panel. The control panel is preferably provided in a graphical user interface for display on a monitor or other visual display. For instance, the control panel can be a visual screen of an application executed by a computer system. The application can be a local application or a web application. The control panel can also be part of an enterprise portal to which only specific users are entitled access.

At 404, the control panel provides a selection of the disk media on which live data is to be securely written to not allow data to be hidden on the disk. The selection of disk media can include CD-R, CD-RW, DVD, etc. At 406, the control panel provides selections of data burning and encryption capabilities, so that a user can select, among other options, whether the disk writing is to be done locally or over a network, the level of security related to an allowable user, which encryption protocol may be used, etc.

Use of a network to burn data to a disk, or to save a copy of the data to another memory device, requires additional security measures. At 408, the control panel provides an option for the live data to be copied or saved to another memory or network storage. If the user does not want to generate a network copy, at 412, the disk media security system burns the disk according to the security protocol described above with reference to FIG. 5. If a network copy is to be generated, at 414 the user is prompted whether a network connection exists or is currently active. If not, the disk media security system is disabled at 416, or at least the functionality for saving a network copy is disabled. If yes, at 418 the disk media security system burns the disk and stores data to a network storage device, such as a networked disk drive or other storage media. The option to store all data written to disk is preferably configured by an Administrator per organizational policies, and not according to user preferences.

Some or all of the functional operations described in this specification can be implemented in digital electronic circuitry, or in computer software, firmware, or hardware, including the structures disclosed in this specification and their structural equivalents, or in combinations of them. If implemented in part as software, installation of the software can include a simple script or document with administrative settings for easy installation and standardized configuration.

Variations of the disk media security system and method can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

1. A method for secure writing to a disk, the method comprising:
providing live data for being written to the disk;
determining a free space of the disk after the live data is written to the disk generating random bits; and
writing at least some of the random bits to fill the free space of the disk in a first part of a write process; and
writing the live data to the disk in a second part of the write process adapted to begin at a terminus of the free space on the disk and continue until all of the live data is written to the disk.

2. The method in accordance with claim 1, wherein the disk is selected from the group of disks that consists of: CD-R, CD-RW, and DVD disks.

3. The method in accordance with claim 1, further comprising writing a first portion of the random bits to the disk in the first part of the write process prior to writing the live data to the disk.

4. The method in accordance with claim 3, further comprising writing a remaining portion of the random bits to the disk after writing the live data to the disk for filling the remaining free space.

5. The method in accordance with 1, further comprising:
determining an encryption policy for the write process; and
encrypting the live data according to the encryption policy.

6. The method in accordance with claim 5, wherein encrypting the live data occurs before writing the live data to the disk.

7. The method in accordance with claim 1, further comprising calculating the free space of the disk.

8. A method for secure writing to a disk, the method comprising:
accessing one or more files of information from a memory;
determining a live space on the disk for the one or more files of information;
calculating a free space on the disk based on the space on the disk for the one or more files of information;
writing the one or more files of information to the live space on the disk in a burn process;
generating random data for filling the free space; and
writing the random data to the free space of the disk.

9. The method in accordance with claim 8, wherein the disk is selected from the group of disks that consists of: CD-R, CD-RW, and DVD disks.

10. The method in accordance with claim 1, further comprising writing a first portion of the random data to the free space of the disk in a first part of the burn process prior to writing the one or more files of information to the live space on the disk.

11. The method in accordance with claim 10, further comprising writing a remaining portion of the random data to the disk after writing the live data to the live space on the disk to fill remaining free space.

12. The method in accordance with 8, further comprising:
determining an encryption policy for the write process; and
encrypting the one or more files of information according to the encryption policy.

13. The method in accordance with claim 12, wherein encrypting the one or more files of information occurs before writing the one or more files of information to the live space on the disk.

14. The method in accordance with claim 8, wherein calculating the free space on the disk occurs before writing the one or more files of information to the live space on the disk.

15. A system for secure writing to a disk, the system comprising:
a memory that stores live data for being written to the disk;
a processor that determines a free space of the disk after the live data is written to the disk;
a random bit generator that generates random bits; and
a data writer under control of the processor for accessing the live data from the memory, writing at least some of the random bits to fill the free space of the disk in a first part of a write process, and writing the live data to the disk in a second part of the write process adapted to begin at a terminus of the free space on the disk and continue until all of the live data is written to the disk.

16. The system in accordance with claim 15, wherein the disk is selected from the group of disks that consists of: CD-R, CD-RW, and DVD disks.

17. The system in accordance with claim 1, wherein the disk writer is further configured for writing a first portion of the random data to the free space of the disk in a first part of the burn process prior to writing the one or more files of information to the live space on the disk.

18. The system in accordance with claim 17, wherein the disk writer is further configured for writing a remaining portion of the random data to the disk after writing the live data to the live space on the disk to fill remaining free space.

19. The system in accordance with 15, further comprising:
an encryption processor that determines an encryption policy for the write process, and encrypts the one or more files of information according to the encryption policy.

20. The system in accordance with claim 15, further comprising a computing system that hosts the processor, the random bit generator, and the disk writer.
